(19) United States
(12) Patent Application Publication
(10) Pub. No.: US 2024/0417562 A1
(43) Pub. Date: Dec. 19, 2024

(54) HIGH-STRENGTH AND HIGH-TOUGHNESS FLAME-RETARDANT THERMOPLASTIC POLYPHENYLENE ETHER COMPOSITE MATERIAL AND APPLICATION THEREOF

(71) Applicant: Guangdong Xingshengdi Technology Co., Ltd., Dongguan (CN)

(72) Inventors: Haifeng Tu, Dongguan (CN); Rongqiao Xie, Dongguan (CN); Shan He, Dongguan (CN)

(21) Appl. No.: 18/675,241

(22) Filed: May 28, 2024

(30) Foreign Application Priority Data
Jun. 16, 2023 (CN) 202310716341.8

(51) Int. Cl. C08L 71/12; C08K 5/20; C08K 5/526; H01R 13/533; H02S 40/36

(52) U.S. Cl. CPC C08L 71/123; C08K 5/20; C08K 5/526; C08K 2201/014; C08L 2201/02; C08L 2201/08; C08L 2203/30; C08L 2205/025; C08L 2205/035; C08L 2205/08; H01R 13/533; H02S 40/36

(57) ABSTRACT

The present invention relates to a high-strength, warping-resistant, flame-retardant PC composite material and application thereof. Raw materials for preparing the high-strength, warping-resistant, flame-retardant PC composite material provided by the present invention include the following components by weight: 100 parts of PC, 7-15 parts of a reinforcer, 1-8 parts of a toughener; 3-12 parts of a fire retardant, 0.1-3 parts of an antioxidant; 0.1-3.5 parts of a lubricant, and 0-3 parts of another processing aid, wherein the PC is a composite PC raw material obtained by mixing PC raw materials of different viscosities; the reinforcer includes a glass fiber and a glass microsphere, and a mass ratio of the glass fiber to the glass microsphere is 1:(0.5-1.5). With excellent tensile strength, bending strength, modulus, impact strength and other properties, the composite material provided by the present invention is a high-performance composite material with high strength and rigidity.

### CROSS-REFERENCE TO RELATED APPLICATION

The present application claims priority from Chinese Patent Application No. 202310716341.8 filed on Jun. 16, 2023, the contents of which are incorporated herein by reference in their entirety.

### FIELD OF THE INVENTION

The invention relates to the technical field of material processing for photovoltaic power generation devices, and in particular to a high-strength and high-toughness flame-retardant thermoplastic PPE composite material and an application thereof.

### BACKGROUND OF THE INVENTION

Solar cells are one of the core components in solar power generation systems. In order to meet the needs of practical applications, multiple solar panels need to be formed into a solar cell array by virtue of photovoltaic connectors to obtain the required voltage and current. Because the connectors are exposed to strong light along with the power generation system and the environment and climate in which they are used are sometimes harsh, the connectors must have good high-temperature resistance, corrosion resistance, aging resistance, weather resistance, and other properties.

Polyphenylene ether (PPE) has high strength, high-temperature resistance, flame retardancy and other properties because of its relatively regular rigid molecular structure. As one of the emerging engineering plastics, the PPE is widely used. In addition, methyl groups in the molecular chain of the PPE block the activity of two ortho-positions of a phenolic hydroxyl group, thereby improving the stability, chemical resistance, heat resistance and other properties of the PPE. However, a large number of aromatic rings and other rigidities in its molecular structure increase the difficulty of intramolecular rotation and significantly increases its melting point and softening point, so the PPE is difficult to process. In response to the difficult processing problem of PPE materials, existing solutions disclose physical blending of PPE materials with other thermoplastic materials to achieve good fluidity and processing properties. Such thermoplastic materials include PS, PA, PET, PB, and EP. By way of blending, the composite materials can give play to their strength and avoid weaknesses, and have the processability and other properties of other thermoplastic materials. For example, a composite material having better processability and cost reduction is obtained by blending HIPS (high-impact polystyrene) which has excellent melt fluidity with PPE. However, although the addition of the HIPS can effectively improve the fluidity and processability of the material, it significantly reduces the flame retardancy of the composite material, so a certain amount of additional flame retardant needs to be added. However, the addition of the flame retardant will reduce the tensile strength, notched impact strength, and the like of the composite material. The Applicant has found in previous studies that the composite material achieves the optimal flame retardancy when the amount of the flame retardant added reaches about 12%, but the tensile strength of the composite material is affected very obviously in this case. Moreover, since the aging resistance of the HIPS material is not as good as that of PPE, during the use of a connector product, the aging and degradation of the HIPS material will produce oxygen-containing groups such as hydroxyl and carbonyl, which will accelerate the aging of the PPE material in its body structure, thus affecting the service life of the composite material badly. Moreover, since the cohesive density of HIPS is relatively weak, the high content of HIPS in the composite material will also cause a decrease in tensile strength and heat distortion temperature.

### SUMMARY

An objective of the invention is to provide a high-strength and high-toughness flame-retardant thermoplastic PPE-PS composite material to solve the problem of using a small amount of polystyrene (PS) to improve the processability of PPE without reducing the flame retardancy, mechanical strength and aging resistance of the composite material. By using a small amount of PS and flame retardants, the excellent processability and flame retardancy of the composite material can be ensured, and a PPE composite material with higher strength, toughness and other properties can be obtained.

In view of the above technical problem, a first aspect of the invention provides a high-strength and high-toughness flame-retardant thermoplastic PPE composite material, comprising, by weight:
100 parts of PPE resin;
8-15 parts of HIPS resin;
8-13 parts of a halogen-free flame retardant;
0.5-3 parts of a lubricant/dispersant;
0.5-2 parts of an anti-UV agent;
2-8 parts of a toughener;
0.5-2 parts of a compatibilizer; and
0-2 parts of other auxiliary agents;
wherein the toughener comprises a high-styrene SEBS and a styrene content in the structure of the high-styrene SEBS is not less than 40%.

As a preferred technical solution of the invention, a melt flow rate of the HIPS resin at 200° C./10 kg is within a range of 35 g/10 min to 45 g/10 min.

As a preferred technical solution of the invention, the styrene content in the structure of the high-styrene SEBS is within a range of 45% to 60%.

As a preferred technical solution of the invention, the toughener further comprises a low-styrene SEBS, and the styrene content in the structure of the low-styrene SEBS is within a range of 28% to 33%; a mass ratio of the high-styrene SEBS to the low-styrene SEBS is 1:(2-4).

As a preferred technical solution of the invention, the lubricant/dispersant comprises an aliphatic amide and a functional compound, and the functional compound contains an aromatic benzene ring in its molecular structure; preferably, the functional compound is N-hexadecylbenzamide.

As a preferred technical solution of the invention, the functional compound accounts for half or more of the weight of the lubricant/dispersant.

As a preferred technical solution of the invention, the halogen-free flame retardant is a phosphorus-containing flame retardant.

As a preferred technical solution of the invention, the compatibilizer is selected from one or more of maleic anhydride-grafted PS, maleic anhydride-grafted PPE, and maleic anhydride-grafted SEBS.

As a preferred technical solution of the invention, the other auxiliary agents comprise an anti-drip agent and an antioxidant.

A second aspect of the invention provides an application of the high-strength and high-toughness flame-retardant thermoplastic PPE composite material as described above in the field of photovoltaic power generation systems.

### Beneficial Effect

Compared with the prior art, the above thermoplastic PPE composite material of the invention has the following beneficial effects:

In the application, by adjusting the formula of the composite material and adding appropriate anti-UV agents, antioxidants, anti-drip agents, flame retardants and other auxiliary agents, the weather resistance, aging resistance, flame retardancy and other properties of the composite material are effectively improved, thereby further broadening the application scope of the composite material. In addition, in the application, by optimizing and adjusting the components such as tougheners and dispersant/lubricants and their proportions, under the interaction between PPE resin, high-impact polyethylene resin, SEBS and other components in the system, the processability of the composite material is ensured, a small amount of HIPS and flame retardant components are used to achieve higher improvements in overall properties such as tensile strength, modulus, impact strength and flame retardancy, thereby effectively improving the processability and impact properties of the composite material without sacrificing mechanical strength, toughness and other properties. Moreover, by adjusting the composition of the formula, flame retardancy and other properties are ensured, and the use amount of auxiliary agents such as flame retardants can be reduced, thereby effectively avoiding the damage of these auxiliary agents to the microscopic stacking structure of polymer components such as PPE resin, and effectively improving the long-term stability and service life of the composite material.

### DETAILED DESCRIPTION

When contents, amounts, or other values or parameters in the application are expressed as ranges, preferred ranges, or ranges defined by a series of preferred upper limits and preferred lower limits, this should be understood as specifically disclosing all ranges formed by any pairing of any upper range limit or preferred value with any lower range limit or preferred value, regardless of whether the range is separately disclosed. For example, in a case where a range “2 to 8” is disclosed, the described range should be interpreted as including ranges “2 to 8”, “2 to 7”, “2 to 6”, “2 to 5 and 6, 7”, and “2 to 3 and 4 to 8”.

When a numerical range is described herein, unless otherwise stated, the range is intended to include the endpoints thereof and all integers and fractions within the range. The singular includes the plural unless the context clearly indicates otherwise. “Optional” or “any” means that the matter or event subsequently described may or may not occur, and the description includes circumstances in which the event occurs and circumstances in which the event does not occur.

The PPE composite material of the invention is a material obtained by blending PPE with PS and other elastomers. The elastomers herein are added mainly for enhancing the toughness. In the application, the term “toughener” and elastomers are actually pronouns referring to the same type of components from different dimensions. The PPE resin described in the application is a polymer resin material obtained by oxidative acetalation of a dimethylphenol monomer in the presence of a catalyst. The preparation method of the PPE resin is not particularly limited in the application. It can be prepared in a manner well known to those skilled in the art. The PPE resin in the application may also be commercially available.

The high-strength and high-toughness flame-retardant thermoplastic PPE composite material of the invention comprises, by weight, 100 parts of PPE resin, 8-15 parts of HIPS resin, 8-13 parts of a halogen-free flame retardant, 0.5-3 parts of a lubricant/dispersant, 0.5-2 parts of an anti-UV agent, 2-8 parts of a toughener, 0.5-2 parts of a compatibilizer, and 0-2 parts of other auxiliary agents; the toughener comprises a high-styrene SEBS and a styrene content in the structure of the high-styrene SEBS is not less than 40%.

The PPE composite material of the application is mainly used as a material for connector components in photovoltaic power generation systems, which have high requirements on the insulation, corrosion and aging resistance, strength, and the like of the PPE composite material. Therefore, in the application, PPE having an intrinsic viscosity of greater than 38 dL/g is preferred. In some preferred embodiments, the intrinsic viscosity of the PPE is within a range of 38 dL/g to 52 dL/g, and further preferably, its intrinsic viscosity is within a range of 43 dL/g to 52 dL/g. Exemplarily, its intrinsic viscosity may be 43 dL/g, 44 dL/g, 45 dL/g, 46 dL/g, 47 dL/g, 48 dL/g, 49 dL/g, 50 dL/g, 51 dL/g, 52 dL/g, or the like. The term “intrinsic viscosity”, as used herein, refers to the reduced viscosity when the concentration of a polymer solution approaches zero. In the application, it can be measured in a manner well known to those skilled in the art.

There are no special restrictions on the specific source of the PPE in the application. Various commercially available PPE resin raw materials may be used, including but not limited to LX040, LX045, LX050 and other brands of polyphenylene ether resin materials from the Blue Star Company.

The PS resin described in the application is HIPS resin, which is a thermoplastic material made of elastomer-modified polystyrene. In the application, continuous polystyrene and rubber phases can be used to prepare the HIPS for use, or commercially available resin raw materials may also be used. In the application, good processability of the PPE material and appropriate impact strength and other properties of the composite material are ensured, the use amount of the HIPS material is also reduced to avoid the reduction of the flame retardancy of the composite material. In the application, based on 100 parts, by weight, of the PPE resin, the content of the HIPS resin in the composite material does not exceed 15 parts by weight, preferably 8 parts to 15 parts by weight.

Further, the HIPS resin described in the application preferably is HIPS having a melt flow rate within a specific range. Preferably, the melt flow rate of the HIPS resin at 200° C./10 kg is within a range of 35 g/10 min to 45 g/10 min. Further preferably, the melt flow rate of the HIPS resin at 200° C./10 kg is within a range of 38 g/10 min to 42 g/10 min. Further preferably, the IZOD notched impact strength (⅛″) of the HIPS resin is within a range of 8 KJ/m² to 14 KJ/m². In the application, the source of the HIPS is not particularly limited in the application. Commercially available raw materials may be used, including but not limited to products of PH-88, PH-88S and other brands.

The term “melt flow rate”, as used herein, also known as the mass flow rate of melt, refers to the number of grams of melt flowing out of the resin material through a standard capillary tube in a certain time (e.g., 10 min) at a certain temperature and load pressure. It may be obtained by testing in a manner well known to those skilled in the art.

The toughener described in the application is SEBS, which is a linear three-embedded copolymer with polystyrene as a terminal segment and an ethylene-butene copolymer obtained by hydrogenating polybutadiene as a middle elastic block. Since the molecular structure of the PPE resin contains a large number of benzene rings and other groups, its chain segments are too rigid, which seriously affects its toughness. In the application, an appropriate amount of a SEBS component is added to improve the toughness of the composite material and increase the modulus. The SEBS used in the PPE composite material of the application is a mixture of one or more SEBS materials of different properties.

In the process of completing the application, it is found that the toughness of the composite material can be effectively improved by adjusting the specific composition and proportion of the SEBS component. When two SEBS materials with different molecular structures and physical and chemical properties are mixed for use, the elongation at break, impact strength, and tensile strength of the composite material are greatly improved. Therefore, in some preferred embodiments of the application, a mixture of two or more SEBS materials of different properties is used, and further preferably, a high-styrene SEBS is comprised therein. The styrene content in the structure of the high-styrene SEBS is not less than 40%, and the styrene content described in the application refers to the mass content. Preferably, the styrene content in the structure of the high-styrene SEBS is within a range of 45% to 60%. Exemplarily, the styrene content in the structure of the high-styrene SEBS may be 45%, 46%, 47%, 48%, 49%, 50%, 51%, 52%, 53%, 54%, 55%, 56%, 57%, 58%, 59%, 60%, or the like.

In some preferred embodiments of the application, the toughener further comprises a low-styrene SEBS. The low-styrene SEBS described in the application refers to a SEBS with a styrene content of less than 40%. Preferably, the styrene content in the structure of the low-styrene SEBS is within a range of 28% to 33%. Further preferably, the styrene content in the structure of the low-styrene SEBS is within a range of 30% to 33%. Exemplarily, the styrene content in the structure of the low-styrene SEBS may be 28%, 29%, 30%, 31%, 31.5%, 32%, 32.5%, 33%, or the like.

The source of the SEBS is not particularly limited in the application. Various SEBS raw materials that are well known to those skilled in the art and meet the above requirements may be used, including but not limited to SEBS products from Kraton Corporation, such as G1651, E1818, G1654, G1650, G1660, G1652, G1657, G1701, G1641, RP6935, RP6936, and the like.

In some preferred embodiments of the application, a mass ratio of the high-styrene SEBS to the low-styrene SEBS is 1:(2-4). Optionally, the mass ratio of the high-styrene SEBS to the low-styrene SEBS is 1:2, 1:2.2, 1:2.5, 1:2.8, 1:3, 1:3.2, 1:3.4, 1:3.5, 1:3.8, 1:4, or the like. Further preferably, the mass ratio of the high-styrene SEBS to the low-styrene SEBS is 1:2.5. It is speculated that when the SEBS elastomers are mixed into the composite material, due to the large difference in the molecular structure between the two different SEBS materials, the difference in stacking manner between a cyclic styrene structure and a chain-like ethylene/butene leads to large differences in the microstructure of the mixture. When the PPE, the HIPS and other materials are dispersed with other components in the system, they diffuse into different three-dimensional network structures formed by the SEBS. When a composite material sample is subjected to external stress, the stacked materials with more chain-like structures absorb the transmitted stress through deformation, thereby effectively preventing the effect of external stress on rigid ring-shaped materials. When the sample is subjected to large external stress during impact tests, these chain-like network structures are broken, thereby absorbing a large amount of impact energy produced, reducing the damage of the impact energy to the microstructure of the sample, and allowing the sample to withstand higher impact energy. In this way, the tensile strength, impact strength and other properties of the material are effectively improved. However, it is also found that the SEBS components used should not be quite different in structure, and the ratio of the components also should be appropriate, otherwise the mechanical properties of the composite material will not be significantly improved.

The specific type of the halogen-free flame retardant is not particularly limited in the application. Various halogen-free flame retardants well known to those skilled in the art may also be used, including but not limited to inorganic flame retardants, nitrogen-containing flame retardants, silicon-based flame retardants, and phosphorus-containing flame retardants. Preferably, the application adopts a phosphorus-containing flame retardant which includes one or more of polyaryl phosphate, resorcinol tetraphenyl diphosphate and bisphenol A bis(diphenyl phosphate) (BDP).

The compatibilizer described in the application is a component capable of improving the compatibility between the PPE, the HIPS, the toughener and other components. In the application, polar group-grafted PPE, HIPS, SEBS and other components may be used in the application. In some preferred embodiments, the compatibilizer is selected from one or more of maleic anhydride-grafted PPE, maleic anhydride-grafted PS, and maleic anhydride-grafted SEBS.

Maleic anhydride-grafted components (PS, PPE, SEBS) described in the application refer to compounds obtained by a grafting reaction between maleic anhydride polar compounds and PS, PPE, SEBS and other components. The preparation method by the grafting reaction is not particularly limited in the application, and they may be prepared in a manner well known to those skilled in the art. In some preferred embodiments, the grafting rate of maleic anhydride in the maleic anhydride-grafted SEBS is within a range of 0.6% to 2%; further preferably, the grafting rate is within a range of 1% to 1.5%. The term “grafting rate”, as used herein, refers to the mass content of maleic anhydride in a polymer. In the application, it may be measured in a manner well known to those skilled in the art.

The lubricant/dispersant in the application is a component used to improve the processability of a material and increase product yield. In the application, components of which the molecular structure contains both polar and non-polar chain segments may be used to improve the mutual migration and flow of macromolecular chain segments of the PPE, SEBS, and HIPS components.

In some preferred embodiments, the lubricant/dispersant comprises an aliphatic amide, including but not limited to oleamide, erucyl amide, stearamide, behenamide, ethylene bisstearamide, ethylene bisoleamide, and octadecyl erucamide, and the lubricant/dispersant may also comprise stearate.

In some preferred embodiments, the lubricant/dispersant further comprises a functional compound, and the functional compound contains aromatic rings in its molecular structure. The functional compound containing aromatic rings in its structure described in the application is a compound containing benzene rings in its molecular structure and having long non-polar alkyl chains and polar groups. In some preferred embodiments, the functional compound is N-hexadecylbenzamide (CAS: 82684-41-1).

In some preferred embodiments of the application, the mass ratio of the aliphatic amide to the functional compound is 1:(1-2). Exemplarily, the ratio may be 1:1, 1:1.2, 1:1.5, 1:1.7, 1:1.8, 1:2, or the like. Preferably, the mass ratio of the aliphatic amide to the functional compound is 1:2. In the process of completing the application, it is found that when the content of HIPS in the composite material is high, the flame retardancy of the composite material is seriously reduced. The addition of the flame retardant to achieve better flame retardant effects reduces the mechanical properties of the composite material to a great extent, especially when the use amount of the flame retardant exceeds 12%, its adverse effect on the mechanical properties of composite materials is particularly obvious. In the process of adjusting the lubricant component to improve the processability of the material, it is found that by using conventional aliphatic amide lubricants and also adding similar components containing benzene rings, the melt extrusion effect of the material can be improved and the mechanical properties of the material may also be significantly improved and moreover, the composite material can be processed well with use of a small amount of the HIPS component and the flame retardant. Even when the use amount of the flame retardant component is large and exceeds 12%, its adverse effect on the mechanical properties of the composite can be significantly avoided.

In the application, in order to further improve the UV aging resistance of the composite material, the raw materials for preparing the composite material include an anti-UV agent. The specific type of the anti-UV agent in the application is not particularly limited. Various anti-UV agents well known to those skilled in the art may be used, including but not limited to benzoic acids, benzophenones, benzotriazoles, and some hindered amines, such as UV-531, 2-hydroxy-4-n-octyloxybenzophenone, UV-2908, UV-326, 3,5-di-tert-butyl-4-hydroxybenzoate n-hexadecyl ester, 2′-(2′-hydroxy-3′-tert-butyl-5′-methylphenyl)-5-chlorobenzotriazole, and 2,2′-methylene bis(4-tert-octyl-6-benzotriazolephenol).

The raw materials for preparing the PPE composite material of the application may further comprise other auxiliary agents. The specific selection of other auxiliary agents is not particularly limited in the invention and they may be added according to the functional requirements of the material. In some preferred embodiments, the other auxiliary agents include but are not limited to an anti-drip agent and an antioxidant.

In some embodiments, the anti-drip agent is an ultra-high molecular weight polytetrafluoroethylene material (UHMWPE) (its molecular weight is greater than 1 million. In some embodiments, the molecular weight of the UHMWPE is within a range of 4 million to 5 million). Further preferably, the UHMWPE is polar polymer-coated polytetrafluoroethylene, and further, the polar polymer-coated polytetrafluoroethylene is MMA-coated polytetrafluoroethylene micro powder. The specific source of the MMA-coated polytetrafluoroethylene is not particularly limited in the application. Various commercially available MMA-coated polytetrafluoroethylene anti-drip agents may be used, such as Korean Hanna FS-100. It is found that although the addition of the anti-drip agent can improve the flame retardancy of the composite material to a large extent and help reduce the use amount of the flame retardant, the anti-drip agent is not well dispersed in PPE, HIPS and other materials of the composite material, seriously affecting the elongation at break, impact strength and other properties of the composite material. By using two SEBS tougheners with different styrene contents and the lubricant/dispersant containing a specific proportion of N-hexadecylbenzamide at the same time, the above problem can be solved to a large extent and the reduction in impact resistance and mechanical strength caused by the addition of anti-drip agents can be significantly ameliorated.

The specific type of the antioxidant is not particularly limited in the application. Various antioxidants well known to those skilled in the art may be used, including but not limited to aromatic amine antioxidants, hindered phenolic antioxidants, and hindered amine antioxidants, and, exemplarily, the antioxidant includes but is not limited to antioxidant 1010, antioxidant 168, antioxidant 1076, antioxidant DLTDP, antioxidant DSTDP, and bis(2,6-di-tert-butyl-4-methylphenyl) pentaerythritol diphosphate (antioxidant RCPEP36).

The high-strength and high-toughness flame-retardant thermoplastic PPE composite material comprises, by weight:
100 parts of PPE resin;
8-15 parts of HIPS resin;
8-11 parts of a halogen-free flame retardant;
0.5-3 parts of a lubricant/dispersant;
0.5-2 parts of an anti-UV agent;
2-8 parts of a toughener;
0.5-2 parts of a compatibilizer;
0.1-0.5 parts of an anti-drip agent; and
0.5-1 part of an antioxidant.

Further preferably, the high-strength and high-toughness flame-retardant thermoplastic polyphenylene ether composite material comprises, by weight:
100 parts of PPE resin;
8-15 parts of HIPS resin;
8-11 parts of a halogen-free flame retardant;
0.3 parts of an aliphatic amide lubricant/dispersant;
0.6 part of a benzene ring-containing functional compound dispersant/lubricant;
0.5-2 parts of an anti-UV agent;
2 parts of a high-styrene SEBS;
5 parts of a low-styrene SEBS;
0.5-2 parts of a compatibilizer;
0.1-0.5 parts of an anti-drip agent; and
0.5-1 part of an antioxidant.

In the invention, the preparation method of the composite material described above is not particularly limited. It may be prepared and used in a manner well known to those skilled in the art. For example, a twin-screw extruder may be used for extrusion and melt extrusion processing. For example, in some embodiments, the components described above may be well stirred and then placed in a twin-screw extruder with a screw speed of 360 to 420 rpm, where the temperatures of zones in the twin-screw extruder are set as follows: 160° C. in Zone 1, 270° C. in Zone 2, 275° C. in Zone 3, 275° C. in Zone 4, 270° C. in Zone 5, 240° C. in Zone 6, 245° C. in Zone 7, 250° C. in Zone 8, 255° C. in Zone 9, and 275° C. in the die; and after extrusion and granulation, the high-strength and high-toughness flame-retardant thermoplastic PPE composite material is obtained.

The application will be described in detail below by examples. It should also be noted here that the following examples are only used to further illustrate the invention and cannot be understood as limiting the scope of the invention. Some non-essential improvements and adjustments made by those skilled in the art according to the above content of the invention still fall within the scope of the invention.

### Example 1

This example provides a high-strength and high-toughness flame-retardant thermoplastic PPE composite material, comprising, by weight:
100 parts of PPE resin;
9 parts of HIPS resin;
10 parts of a halogen-free flame retardant;
0.3 parts of an aliphatic amide lubricant/dispersant;
0.6 part of a benzene ring-containing functional compound dispersant/lubricant;
1 part of an anti-UV agent;
2 parts of a high-styrene SEBS;
5 parts of a low-styrene SEBS;
1 part of a compatibilizer;
0.5 parts of an anti-drip agent; and
0.6 parts of an antioxidant;

The average intrinsic viscosity of the PPE resin (LXR045) is 45 dL/g; the melt flow rate of the HIPS resin (PH-88S) at 200° C./10 kg is 40 g/10 min and the IZOD notched impact strength of the HIPS resin is 10.5 KJ/m²; the halogen-free flame retardant is bisphenol A bis(diphenylphosphate) (BDP); the aliphatic amide lubricant/dispersant is ethylene bisoleamide; the benzene ring-containing functional compound dispersant/lubricant is N-hexadecylbenzamide; the styrene content of the high-styrene SEBS is 58% (RP6935); the styrene content of the low-styrene SEBS is 33% (G1651); the anti-UV agent is UV-326; the compatibilizer is maleic anhydride-grafted SEBS (FG1901), wherein the styrene content of the SEBS is 30% and the grafting rate is 1.5%; the anti-drip agent is MMA-coated polytetrafluoroethylene (FS-100); the antioxidant is antioxidant RCPEP36.

The preparation method of the composite material described above comprises the following steps:

adjusting the temperatures of nine zones of a twin-screw extruder, heating to set temperatures (160° C. in Zone 1, 270° C. in Zone 2, 275° C. in Zone 3, 275° C. in Zone 4, 270° C. in Zone 5, 240° C. in Zone 6, 245° C. in Zone 7, 250° C. in Zone 8, 255° C. in Zone 9, and 275° C. in the die); weighing 100 kg of the PPE resin, 9 kg of the HIPS resin, and 7 kg of the SEBS (a mixture of the SEBS components in a ratio of 1:2.5) according to the above formula proportions, drying these components at 80° C. for 12 h, then cooling the components to room temperature; and then weighing 10 kg of the flame retardant, 0.9 kg of the lubricant/dispersant (a mixture of lubricants and dispersants in a ratio of 1:2), 1 kg of the anti-UV agent, 1 kg of the compatibilizer, 0.5 kg of the anti-drip agent, and 0.6 kg of the antioxidant; well stirring and mixing all the above components, placing the resulting mixture in the set twin-screw extruder to carry out heating and melt extrusion at a screw speed of about 400 rpm, and then carrying out extrusion, granulation, and drying to obtain the high-strength and high-toughness flame-retardant thermoplastic PPE composite material.

### Example 2

This example provides a high-strength and high-toughness flame-retardant thermoplastic PPE composite material, comprising, by weight:
100 parts of PPE resin;
16 parts of HIPS resin;
14 parts of a halogen-free flame retardant;
0.3 parts of an aliphatic amide lubricant/dispersant;
0.6 part of a benzene ring-containing functional compound dispersant/lubricant;
1 part of an anti-UV agent;
2 parts of a high-styrene SEBS;
5 parts of a low-styrene SEBS;
1 part of a compatibilizer;
0.5 parts of an anti-drip agent; and
0.6 parts of an antioxidant;

The average intrinsic viscosity of the PPE resin (LXR045) is 45 dL/g; the melt flow rate of the HIPS resin (PH-88S) at 200° C./10 kg is 40 g/10 min and the IZOD notched impact strength of the HIPS resin is 10.5 KJ/m²; the halogen-free flame retardant is bisphenol A bis(diphenylphosphate) (BDP); the aliphatic amide lubricant/dispersant is ethylene bisoleamide; the benzene ring-containing functional compound dispersant/lubricant is N-hexadecylbenzamide; the styrene content of the high-styrene SEBS is 58% (RP6935); the styrene content of the low-styrene SEBS is 33% (G1651); the anti-UV agent is UV-326; the compatibilizer is maleic anhydride-grafted SEBS (FG1901), wherein the styrene content of the SEBS is 30% and the grafting rate is 1.5%; the anti-drip agent is MMA-coated polytetrafluoroethylene (FS-100); the antioxidant is antioxidant RCPEP36.

The preparation method of the composite material described above comprises the following steps:
adjusting the temperatures of nine zones of a twin-screw extruder, heating to set temperatures (160° C. in Zone 1, 270° C. in Zone 2, 275° C. in Zone 3, 275° C. in Zone 4, 270° C. in Zone 5, 240° C. in Zone 6, 245° C. in Zone 7, 250° C. in Zone 8, 255° C. in Zone 9, and 275° C. in the die); weighing 100 kg of the PPE resin, 16 kg of the HIPS resin, and 7 kg of the SEBS (a mixture of the SEBS components in a ratio of 1:2.5) according to the above formula proportions, drying these components at 80° C. for 12 h, then cooling the components to room temperature; and then weighing 14 kg of the flame retardant, 0.9 kg of the lubricant/dispersant (a mixture of lubricants and dispersants in a ratio of 1:2), 1 kg of the anti-UV agent, 1 kg of the compatibilizer, 0.5 kg of the anti-drip agent, and 0.6 kg of the antioxidant; well stirring and mixing all the above components, placing the resulting mixture in the set twin-screw extruder to carry out heating and melt extrusion at a screw speed of about 400 rpm, and then carrying out extrusion, granulation, and drying to obtain the high-strength and high-toughness flame-retardant thermoplastic PPE composite material.

### Example 3

This example provides a high-strength and high-toughness flame-retardant thermoplastic PPE composite material, comprising, by weight:
100 parts of PPE resin;
16 parts of HIPS resin;
10 parts of a halogen-free flame retardant;
0.3 parts of an aliphatic amide lubricant/dispersant;
0.6 part of a benzene ring-containing functional compound dispersant/lubricant;
1 part of an anti-UV agent;
7 parts of a low-styrene SEBS;
1 part of a compatibilizer;
0.5 parts of an anti-drip agent; and
0.6 parts of an antioxidant;

The average intrinsic viscosity of the PPE resin (LXR045) is 45 dL/g; the melt flow rate of the HIPS resin (PH-88S) at 200° C./10 kg is 40 g/10 min and the IZOD notched impact strength of the HIPS resin is 10.5 KJ/m²; the halogen-free flame retardant is bisphenol A bis(diphenylphosphate) (BDP); the aliphatic amide lubricant/dispersant is ethylene bisoleamide; the benzene ring-containing functional compound dispersant/lubricant is N-hexadecylbenzamide; the styrene content of the low-styrene SEBS is 33% (G1651); the anti-UV agent is UV-326; the compatibilizer is maleic anhydride-grafted SEBS (FG1901), wherein the styrene content of the SEBS is 30% and the grafting rate is 1.5%; the anti-drip agent is MMA-coated polytetrafluoroethylene (FS-100); the antioxidant is antioxidant RCPEP36.

The preparation method of the composite material described above comprises the following steps:
adjusting the temperatures of nine zones of a twin-screw extruder, heating to set temperatures (160° C. in Zone 1, 270° C. in Zone 2, 275° C. in Zone 3, 275° C. in Zone 4, 270° C. in Zone 5, 240° C. in Zone 6, 245° C. in Zone 7, 250° C. in Zone 8, 255° C. in Zone 9, and 275° C. in the die); weighing 100 kg of the PPE resin, 16 kg of the HIPS resin, and 7 kg of the SEBS according to the above formula proportions, drying these components at 80° C. for 12 h, then cooling the components to room temperature; and then weighing 10 kg of the flame retardant, 0.9 kg of the lubricant/dispersant (a mixture of lubricants and dispersants in a ratio of 1:2), 1 kg of the anti-UV agent, 1 kg of the compatibilizer, 0.5 kg of the anti-drip agent, and 0.6 kg of the antioxidant; well stirring and mixing all the above components, placing the resulting mixture in the set twin-screw extruder to carry out heating and melt extrusion at a screw speed of about 400 rpm, and then carrying out extrusion, granulation, and drying to obtain the high-strength and high-toughness flame-retardant thermoplastic PPE composite material.

### Example 4

This example provides a high-strength and high-toughness flame-retardant thermoplastic PPE composite material, comprising, by weight:
100 parts of PPE resin;
9 parts of HIPS resin;
10 parts of a halogen-free flame retardant;
0.9 parts of an aliphatic amide lubricant/dispersant;
1 part of an anti-UV agent;
7 parts of a high-styrene SEBS;
1 part of a compatibilizer;
0.5 parts of an anti-drip agent; and
0.6 parts of an antioxidant;

The average intrinsic viscosity of the PPE resin (LXR045) is 45 dL/g; the melt flow rate of the HIPS resin (PH-88S) at 200° C./10 kg is 40 g/10 min and the IZOD notched impact strength of the HIPS resin is 10.5 KJ/m²; the halogen-free flame retardant is bisphenol A bis(diphenylphosphate) (BDP); the aliphatic amide lubricant/dispersant is ethylene bisoleamide; the benzene ring-containing functional compound dispersant/lubricant is N-hexadecylbenzamide; the styrene content of the high-styrene SEBS is 58% (RP6935); the anti-UV agent is UV-326; the compatibilizer is maleic anhydride-grafted SEBS (FG1901), wherein the styrene content of the SEBS is 30% and the grafting rate is 1.5%; the anti-drip agent is MMA-coated polytetrafluoroethylene (FS-100); the antioxidant is antioxidant RCPEP36.

The preparation method of the composite material described above comprises the following steps:
adjusting the temperatures of nine zones of a twin-screw extruder, heating to set temperatures (160° C. in Zone 1, 270° C. in Zone 2, 275° C. in Zone 3, 275° C. in Zone 4, 270° C. in Zone 5, 240° C. in Zone 6, 245° C. in Zone 7, 250° C. in Zone 8, 255° C. in Zone 9, and 275° C. in the die); weighing 100 kg of the PPE resin, 9 kg of the HIPS resin, and 7 kg of the SEBS according to the above formula proportions, drying these components at 80° C. for 12 h, then cooling the components to room temperature; and then weighing 10 kg of the flame retardant, 0.9 kg of the lubricant/dispersant, 1 kg of the anti-UV agent, 1 kg of the compatibilizer, 0.5 kg of the anti-drip agent, and 0.6 kg of the antioxidant; well stirring and mixing all the above components, placing the resulting mixture in the set twin-screw extruder to carry out heating and melt extrusion at a screw speed of about 400 rpm, and then carrying out extrusion, granulation, and drying to obtain the high-strength and high-toughness flame-retardant thermoplastic PPE composite material.

### Example 5

This example provides a high-strength and high-toughness flame-retardant thermoplastic PPE composite material, comprising, by weight:
100 parts of PPE resin;
9 parts of HIPS resin;
10 parts of a halogen-free flame retardant;
0.3 parts of an aliphatic amide lubricant/dispersant;
1 part of an anti-UV agent;
7 parts of a low-styrene SEBS;
1 part of a compatibilizer;
0.5 parts of an anti-drip agent; and
0.6 parts of an antioxidant;

The average intrinsic viscosity of the PPE resin (LXR040) is 40 dL/g; the melt flow rate of the HIPS resin (PH-88S) at 200° C./10 kg is 40 g/10 min and the IZOD notched impact strength of the HIPS resin is 10.5 KJ/m²; the halogen-free flame retardant is bisphenol A bis(diphenylphosphate) (BDP); the aliphatic amide lubricant/dispersant is ethylene bisoleamide; the benzene ring-containing functional compound dispersant/lubricant is N-hexadecylbenzamide; the styrene content of the low-styrene SEBS is 33% (G1651); the anti-UV agent is UV-326; the compatibilizer is maleic anhydride-grafted SEBS (FG1901), wherein the styrene content of the SEBS is 30% and the grafting rate is 1.5%; the anti-drip agent is MMA-coated polytetrafluoroethylene (FS-100); the antioxidant is antioxidant RCPEP36.

The preparation method of the composite material described above comprises the following steps:
adjusting the temperatures of nine zones of a twin-screw extruder, heating to set temperatures (160° C. in Zone 1, 270° C. in Zone 2, 275° C. in Zone 3, 275° C. in Zone 4, 270° C. in Zone 5, 240° C. in Zone 6, 245° C. in Zone 7, 250° C. in Zone 8, 255° C. in Zone 9, and 275° C. in the die); weighing 100 kg of the PPE resin, 9 kg of the HIPS resin, and 7 kg of the SEBS according to the above formula proportions, drying these components at 80° C. for 12 h, then cooling the components to room temperature; and then weighing 10 kg of the flame retardant, 0.3 kg of the lubricant/dispersant, 1 kg of the anti-UV agent, 1 kg of the compatibilizer, 0.5 kg of the anti-drip agent, and 0.6 kg of the antioxidant; well stirring and mixing all the above components, placing the resulting mixture in the set twin-screw extruder to carry out heating and melt extrusion at a screw speed of about 400 rpm, and then carrying out extrusion, granulation, and drying to obtain the high-strength and high-toughness flame-retardant thermoplastic PPE composite material.

### Property Testing

Test samples of the same specifications made from the composite materials obtained in the above embodiments were tested for various properties. Specifically:
Tensile strength and elongation at break were tested according to ISO527 standard, with a test rate of 50 mm/min and a sample size of 150 mm*10 mm*4 mm;
Notched impact property was tested according to ISO180/1A standard, with a sample size of 80 mm*10 mm*4 mm;
Xenon lamp aging resistance and color difference ΔE were tested according to ISO4892-2 cycle1 and ASTM D2244 standards;

The test results are shown in Table 1 below.

TABLE 1

| | Tensile | Elongation | Impact | |
|---|---|---|---|---|
| | strength | at break | strength | ΔE |
| Example 1 | 79.7 MPa | 16.2% | 36.8 KJ/m² | 2.6 |
| Example 2 | 64.8 MPa | 39.8% | 25.4 KJ/m² | 2.9 |
| Example 3 | 74.1 MPa | 10.4% | 40.1 KJ/m² | 3.2 |
| Example 4 | 71.4 MPa | 6.7% | 21.8 KJ/m² | 1.9 |
| Example 5 | 63.1 MPa | 22.9% | 38.3 KJ/m² | 3.9 |

The composite materials obtained in the examples were made into 0.8 mm and 2.0 mm thick samples respectively. The samples were tested for flame retardancy according to the UL94 standard and for bending property according to the ISO178 standard (bending rate 20 mm/min). The test results are shown in Table 2 below.

TABLE 2

| | Flame retardacy | Bending | | Flexural |
|---|---|---|---|---|
| | (0.8 mm/2.0 mm) | strength | | modulus |
| Example 1 | V0/V0 | 124 | MPa | 2783 MPa |
| Example 2 | V0/V0 | 102 | MPa | 2208 MPa |
| Example 3 | V2/V1 | 113 | MPa | 2419 MPa |
| Example 4 | V0/V0 | 126 | MPa | 2793 MPa |
| Example 5 | V0/V0 | 96 | MPa | 1937 |

In addition, the melt extrusion state of the composite materials in the above examples and the surface smoothness of the cooled material after extrusion were observed to analyze the melt extrusion properties of the composite materials. It was found that the materials in Examples 1 to 3 and 5 were melted and extruded relatively smoothly, the surface of the cooled materials was smooth, and the interface of the materials after brittle fracture by cooling with liquid nitrogen was also relatively smooth without other obvious separation interfaces or the like; the material in Example 4 had bamboo-like irregularities on its surface during extrusion, and the extrusion effect was significantly worse than that of the materials in other examples.

According to the above test results, it can be seen that by optimizing the formula components and proportions of the PPE composite material, the composite material has higher strength modulus, toughness, flame retardancy, weather resistance and other properties. On the premise of using a smaller amount of HIPS, flame retardants and other components and retaining the core PPE component as much as possible, excellent processability is also ensured and the overall properties of the composite material are improved so that the composite material can exert excellent overall properties in harsh environments such as strong light. So, the composite material is widely used as a raw material for the preparation of connectors and other components in the field of photovoltaic power generation.

The above are only exemplary embodiments of the application and do not limit the scope of the application. That is, all equivalent changes and modifications made based on the teachings of the application are still within the scope of the application. Those skilled in the art will readily conceive of other implementation solutions of the application after considering this description and practicing the content disclosed herein. The application is intended to cover any variations, uses, or adaptive changes of the application. These variations, uses, or adaptive changes follow the general principles of the application and include common knowledge or conventional technical means in the technical field that are not disclosed in the application. The description and the embodiments are regarded as exemplary only, and the true scope and spirit of the application are defined by the claims.

1. A high-strength and high-toughness flame-retardant thermoplastic PPE composite material, comprising, by weight:
100 parts of PPE resin;
8-15 parts of HIPS resin;
8-13 parts of a halogen-free flame retardant;
0.5-3 parts of a lubricant/dispersant;
0.5-2 parts of an anti-UV agent;
2-8 parts of a toughener;
0.5-2 parts of a compatibilizer; and
0-2 parts of other auxiliary agents;
wherein the toughener comprises a high-styrene SEBS and a styrene content in the structure of the high-styrene SEBS is not less than 40%.

2. The high-strength and high-toughness flame-retardant thermoplastic PPE composite material according to claim 1, wherein a melt flow rate of the HIPS resin at 200° C./10 kg is within a range of 35 g/10 min to 45 g/10 min.

3. The high-strength and high-toughness flame-retardant thermoplastic PPE composite material according to claim 1, wherein the styrene content in the structure of the high-styrene SEBS is within a range of 45% to 60%.

4. The high-strength and high-toughness flame-retardant thermoplastic PPE composite material according to claim 3, wherein the toughener further comprises a low-styrene SEBS, and the styrene content in the structure of the low-styrene SEBS is within a range of 28% to 33%; a mass ratio of the high-styrene SEBS to the low-styrene SEBS is 1:(2-4).

5. The high-strength and high-toughness flame-retardant thermoplastic PPE composite material according to claim 1, wherein the lubricant/dispersant comprises an aliphatic amide and a functional compound, and the functional compound contains an aromatic benzene ring in its molecular structure; preferably, the functional compound is N-hexadecylbenzamide.

6. The high-strength and high-toughness flame-retardant thermoplastic PPE composite material according to claim 5, wherein the functional compound accounts for half or more of the weight of the lubricant/dispersant.

7. The high-strength and high-toughness flame-retardant thermoplastic PPE composite material according to claim 1, wherein the halogen-free flame retardant is a phosphorus-containing flame retardant.

8. The high-strength and high-toughness flame-retardant thermoplastic PPE composite material according to claim 1, wherein the compatibilizer is selected from one or more of maleic anhydride-grafted PS, maleic anhydride-grafted PPE, and maleic anhydride-grafted SEBS.

9. The high-strength and high-toughness flame-retardant thermoplastic PPE composite material according to claim 1, wherein the other auxiliary agents comprise an anti-drip agent and an antioxidant.

10. A photovoltaic power generation system, comprising the high-strength and high-toughness flame-retardant thermoplastic PPE composite material according to claim 1.

11. The photovoltaic power generation system to claim 10, wherein a melt flow rate of the HIPS resin at 200° C./10 kg is within a range of 35 g/10 min to 45 g/10 min.

12. The photovoltaic power generation system to claim 10, wherein the styrene content in the structure of the high-styrene SEBS is within a range of 45% to 60%.

13. The photovoltaic power generation system according to claim 12, wherein the toughener further comprises a low-styrene SEBS, and the styrene content in the structure of the low-styrene SEBS is within a range of 28% to 33%; a mass ratio of the high-styrene SEBS to the low-styrene SEBS is 1:(2-4).

14. The photovoltaic power generation system according to claim 10, wherein the lubricant/dispersant comprises an aliphatic amide and a functional compound, and the functional compound contains an aromatic benzene ring in its molecular structure; preferably, the functional compound is N-hexadecylbenzamide.

15. The photovoltaic power generation system according to claim 14, wherein the functional compound accounts for half or more of the weight of the lubricant/dispersant.

16. The photovoltaic power generation system according to claim 10, wherein the halogen-free flame retardant is a phosphorus-containing flame retardant.

17. The photovoltaic power generation system according to claim 10, wherein the compatibilizer is selected from one or more of maleic anhydride-grafted PS, maleic anhydride-grafted PPE, and maleic anhydride-grafted SEBS.

18. The photovoltaic power generation system according to claim 10, wherein the other auxiliary agents comprise an anti-drip agent and an antioxidant.
